(19) United States
(12) Patent Application Publication
(10) Pub. No.: US 2020/0138061 A1
(43) Pub. Date: May 7, 2020

(54) COMPACT-PODS OF NUTRIENTS THAT DISSOLVE IN LIQUID SOLUTIONS AND MANUFACTURING METHODS THEREOF

(71) Applicant: Shoreditch-son Co., Ltd., Onna-Son (JP)

(72) Inventors: Zachary Wayne Bell, Okinawa-ken (JP); Alistair James Brock, Okinawa-ken (JP); Fosca Mirata, Mineo (CT) (IT)

(21) Appl. No.: 16/666,135

(22) Filed: Oct. 28, 2019

Related U.S. Application Data
(60) Provisional application No. 62/750,840, filed on Oct. 26, 2018.

(51) Int. Cl. A23L 2/395; A23F 5/38; A23F 5/40; A23F 5/42; A23F 3/32; A23P 10/20; A23P 20/15

(52) U.S. Cl. CPC A23L 2/395; A23F 5/385; A23F 5/40; A23V 2002/00; A23F 3/32; A23P 10/20; A23P 20/15; A23F 5/42

(57) ABSTRACT

Nutrients and/or nutrient supplements compacted into soluble pods are described, namely the invention is a combination of formulation with compaction methods and coating/encapsulating methods. The formulation includes combining nutrients and/or nutrient supplements with at least one dissolution agent, and with at least one binding agent. The methods include compaction and coating/encapsulating the resulting compact-pod or formula to generate a single serve compact-pod unit that can be dissolved into a beverage or liquid.

### PRIORITY CLAIM

This application claims the benefit of priority from U.S. Provisional Patent Application No. 62/750,840, filed Oct. 26, 2018, the entire contents of which are incorporated by reference.

### FIELD OF THE INVENTION

The invention described here details methods for converting nutrient powders and/or nutrient supplement powders into single compacted pods that can be dissolved into beverages. The invention of this compact-pod is comprised of (a) the formulation of pod-ingredients (i.e., the ingredients that help with compaction and dissolution) with nutrient powders/nutrient supplement powders, (b) processes for compacting the pod-ingredients with nutrient(s) formulation into a solid compact-pod using a mold and (c) processes for adding a protective coating, film, and/or dry encapsulation to the compact-pod; steps (a) and (b) can stand alone as the invention, with step (c) being optional but still part of the invention as it requires at least the completion of step (a) or (b). The resulting compact-pod uses a specific combination of pod-ingredients+nutrients and are compaction occurs in a way that allows for the creation of a solid structure strong enough to be held and manipulated in the hand and/or can withstand a one-meter drop without breaking, but can still readily dissolve (like a bath bomb). This is distinct from simply compacting nutrients/chemicals in a device, like a pill-press, as is typically used in the nutritional and pharmaceutical industries for compacting powders. This application covers the methods/processes of creating compact-pods for all forms of nutrient powders and/or nutrient supplement powders (excluding cannabis-derived compounds). The resulting compact-pod remains a solid-compacted structure when dry but dissociates/dissolves or suspends when placed into an aqueous solution(s) and/or oil(s) and/or organic solvent(s). Compact-pods can be made in a range of sizes (0.1-2000 grams) and in any 3-dimensional shape to suit their intended purpose.

### BACKGROUND OF THE INVENTION

Nutrient supplements, particularly nutrient-containing powders and nutrient-containing granules (or pellets), are commonly mixed into a beverage of choice and consumed to supplement a diet (e.g., whey protein), substitute a meal (e.g., baby formula or meal replacement formulation), or simply be whole foods that have been dried and ground up into powder for easier consumption (e.g., vegetable powders). Nutrient powders/granules and nutrient supplement powders can also be dissolved in liquids and used for non-human animal, plant, and microorganism consumption. Nutrient powders/granules and nutrient supplement powders are readily available for purchase from stores, but include three main drawbacks:

1) Nutrients with Low Solubility Require Vigorous Mixing

The common method of consuming nutrient powders and/or nutrient supplement powders is to add the powers to a solvent (e.g., water), and vice versa, within a standard shaker bottle (FIG. 1), secure the lid, then shake the bottle to mix the contents. Unfortunately, many commercials powders, such as protein powder (e.g., whey, casein, soy, hemp, and pea), are not highly soluble in water, and even with vigorous agitation the powder still has the tendency to clump in the water. Clumping can occur for several reasons, with one example being when the particle size of the powder is too fine, resulting in trapped air space that does not easily become hydrated.

Methods to combat clumping include using a whisk ball to break up the floating clumps (although infective against clumping on the walls of the container), using warmer water to increase soluble (although this results in a less palatable final product), and using an electric blender (inconvenient for on-the-go use and the cleanup is timely). The invention described here, i.e., the compact-pod, alleviates these problems by compacting the nutrient powders/nutrient supplement powders with pod-ingredients (i.e., solubilizing and compacting agents). These pod-ingredients disperse the nutrient powders/nutrient supplement powders into solution, namely by allowing hydration of the nutrient powders/nutrient supplement powders gradually, resulting in decreased clumping due to less trapped air spaces as compared to the nutrient powders/nutrient supplement powders alone. The pod ingredients also allow the powders to be compacted in a way that allows for dissociation of the compact-pod in a solvent (e.g., water).

### 2) Small Particle Size of Nutrients (Powders or Granules/Pellets) Results in Spillage and Thus Wastes

Protein powders are fine powders (an example of a nutrient powder/nutrient supplement powder), which means they can aerosolize easily in breezy conditions and can be spilt when transferring from the original stock bag/container into the shaker (or cup). Aside from the obvious mess, spilling powder has a number of disadvantages including difficulties in tracking the dietary intake (already associated with inaccurate scoop measures), economic implications of lost protein for the consumer, and adding wasted materials to the carbon footprint of humankind. Converting the powders into compact-pods would circumvent all these problems as they provide a powderless solution, which also increases dosing accuracy.

### 3) Standard Packaging is Cumbersome, Making Transportation and Storage Difficult

Protein powder is widely used by health enthusiasts and athletes. This powder is normally sold in bulk to consumers, typically from 500 grams-5 kilograms. It is most commonly sold in cylindrical containers or bags, making personal transportation a burden. Consumers are thus forced to carry powder in smaller sizes for travel or use at the gym (e.g., putting it into a smaller container). Although a few types of shaker bottles contain a small container that screws onto the bottom of the bottle for holding pills and powder. Another problem with standard packaging is that the variety of protein powder types can seem endless, and thus to sample most protein powder means one must invest in half a kilogram or more of it (although some companies do sell single servings packets). In most cases, the container or bag comes with a scoop for measuring out a single serving size of the powder, which tends to be inconveniently buried deep under the powder, making it difficult to find without causing a mess. The compact-pod provides a convenient solution for consumers to be able to carry single servings of a given protein powder. It also provides a sampling solution for both consumers and nutrient/nutrient supplement companies selling the powders.

### SUMMARY OF THE INVENTION

This invention describes the combination of a formulation and processes for converting nutrient powders and/or nutrient supplement powders, such as protein powders, into compact-pods (FIG. 2-4). The nutrient powders and/or nutrient supplement powders, in solid forms (e.g., powders, granules, crystals) and liquids (pre-dissolved powders, granules, crystals), can first be formulated together, and then compacted in a way that reduces messes and wastes during handling, while remaining highly soluble (dissolvable) into liquid solutions/suspensions, with or without agitation from a mixing tool (e.g., spoon) or shaking in a closed container (e.g., shaker bottle). The invention of this compact-pod is comprised of (a) the formulation of pod-ingredients with nutrient powders/nutrient supplement powders, (b) processes for compacting the pod-ingredients+nutrients formulation into a solid compact-pod using a mold and (c) processes for an optional addition of a protective coating. The resulting compact-pod uses a specific combination/ratio of pod-ingredients to nutrients and are compacted in a way that allows for the creation of a solid structure that is strong enough to be held and manipulated in the hand and/or dropped from 1 meter without breaking, but can still readily dissolve (like a bath bomb). This is distinct from simply compacting nutrients/chemicals in a device, like a pill-press, as is typically used in the nutritional and pharmaceutical industries for compacting powders. This application covers the methods of creating compact-pods for all forms of nutrient powders and/or nutrient supplement powders (excluding cannabis-derived compounds).

### BRIEF DESCRIPTION OF THE DRAWINGS

Preferred and alternative examples of the present invention are described in detail below with reference to the following drawings:

FIG. 1: Making a protein shake from protein powder and water

Demonstrates how to make a standard protein shake. Starting with an open protein powder bag or container and a shaker bottle with the top removed, a full scoop of powder is removed from the container and added to the shaker bottle, which results in some accidental spillage. Water is then added to the shaker bottle and the top is screwed on. The bottle is then shaken to mix the powder with the water, which results in partial dissolution of the powder with remaining powder clumps.

FIG. 2: Making a compact-pod

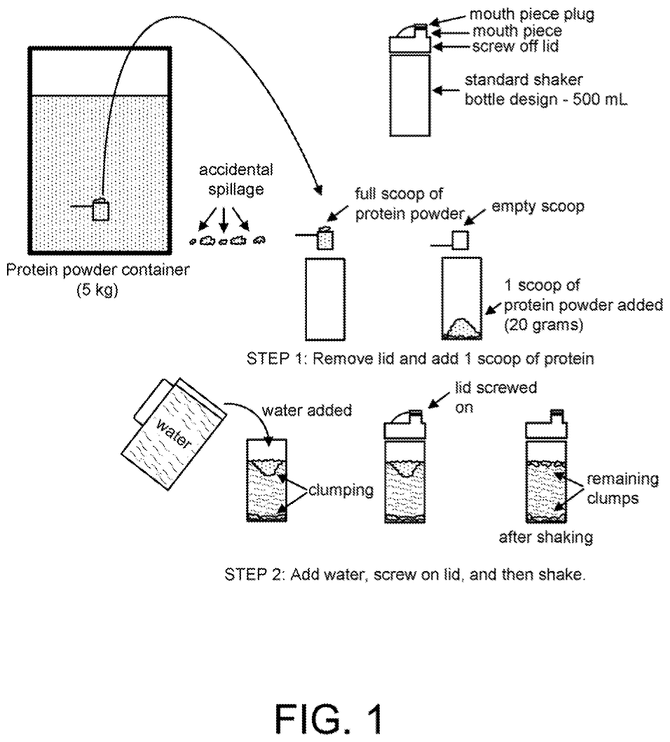

Compact-pods are created from compacting nutrient powders and/or nutrient supplement powders. First, the nutrient type is selected, e.g., nutrient micro/nanoemulsions and micelles, nutrient powder(s), nutrient granule(s) or nutrient liquid(s); and in any combination of these. Second, the nutrients are mixed with pod-ingredients. Third, these are packed into a mold and pressure (e.g., including, but not limited to, mechanical pressure, vacuum pressure, air pressure, and/or electrostatic pressure) is added to compact the nutrients into a compact-pod. Fourth, drying and/or solvent removal from the compact-pod can occur within or outside of the mold using a variety of methods (e.g., using heating/dehydrating, a vacuum oven, freeze-drying, a gas (e.g., nitrogen), and other methods involving gases with or without pressure).

FIG. 3: Making a compact-pod by wet coating

Compact-pods are created from compacting nutrient powders and/or nutrient supplement powders. First, the nutrient type is selected, e.g., nutrient micro/nanoemulsions and micelles, nutrient powder(s), nutrient granule(s) or nutrient liquid(s); and in any combination of these. Second, the nutrients are mixed with one or more pod-ingredients. Third, these are packed into a mold and pressure (e.g., including but not limited to mechanical pressure, vacuum pressure, air pressure, and/or electrostatic pressure) is added to compact the nutrients into a compact-pod. Fourth, drying and/or solvent removal from the compact-pod can occur within or outside of the mold using a variety of methods (e.g., using heating/dehydrating, a vacuum oven, freeze-drying, a gas (e.g., nitrogen), and other methods involving gases with or without pressure). Fifth, a coating is added using methods that include, but are not limited to, spraying, brushing, dipping, or pouring; this may completely or incompletely cover the surface of the compact-pod.

FIG. 4: Making a compact-pod by dry encapsulation

Compact-pods are created from compacting nutrient powders and/or nutrient supplement powders. First, the nutrient type is selected, e.g., nutrient micro/nanoemulsions and micelles, nutrient powder(s), nutrient granule(s) or nutrient liquid(s); and in any combination of these. Second, the nutrients are mixed with one or more pod-ingredients. Third, these are packed into a mold and pressure (e.g., including, but not limited to, mechanical pressure, vacuum pressure, air pressure, and/or electrostatic pressure) is added to compact the nutrients into a compact-pod. Fourth, drying and/or solvent removal from the compact-pod can occur within or outside of the mold using a variety of methods (e.g., using heating/dehydrating, a vacuum oven, freeze-drying, a gas (e.g., nitrogen), and other methods involving gases with or without pressure). Fifth, assemble a hard-shell capsule onto the compact-pod, which may be water soluble, non-water soluble, and may completely or incompletely cover the surface of the compact-pod.

FIG. 5: A schematic of a mold that can generate a capsule or pill-shaped compact-pod (5A: Top-Press; 5B: Base; 5C: Side-Support)

The mold consists of three parts: Top-Press, Base, and Side-Support. The Side-Support fits on top of the Base and the Top-Press fits into the Side-Support. The mold parts can be fabricated from plastics (including, but not limited to, PLA, ABS, and PET), bio-fibers, bio-composites, ceramics, metals (including, but not limited to, aluminum, stainless steel, alloys, magnesium, and copper alloys), silicones, naturally occurring polymers, semisynthetic/synthetic polymers, or other materials that would maintain shape in the form of a mold as described in this document for creating a compact-pod. The mold can be scaled up or down for producing a compact-pod of a desired final volume. The mold in this figure represents a mold for creating a single compact pod, but molds can be assembled in a series for producing more than one compact-pod. To create a compact-pod with a mold, the order of assembly is as follows:
1. Place the Side-Support onto the Base. The Side-Support acts as a funnel.
2. Add the formulation (wet, dry, or some combination of the two) into the Side-Support, which collects mainly in the Base.
3. The Top-Press is then inserted into the Side-Support and pressed down, compacting the formulation into a compact-pod. The mechanical force pressing down on the Top-Press may include, but is not limited to, mechanical pressures, air pressure, or hydraulic pressure.
4. The Top-Press can then be removed, exposing the compact-pod. The compact-pod can then be left to dry as is with the Side-Support still in place or the Side-Support can be removed and the compact-pod can remain in the base and allowed to dry or the compact-pod can be completely removed from the Base (and other parts of the mold) and allowed to dry by itself.
5. After drying the compact-pod, further processing can be carried out on the compact-pod, including but not limited to, further drying/dehydration steps or the addition of coatings.

FIG. 6: A schematic of a mold that can generate a Reuleaux tetrahedron-shaped compact-pod (6A: Top-Press; 6B: Base; 6C: Side-Support)

The mold consists of three parts: Top-Press, Base, and Side-Support. The Side-Support fits on top of the Base and the Top-Press fits into the Side-Support. The mold parts can be fabricated from plastics (including, but not limited to, PLA, ABS, and PET), bio-fibers, bio-composites, ceramics, metals (including, but not limited to, aluminum, stainless steel, alloys, magnesium, and copper alloys), silicones, naturally occurring polymers, semisynthetic/synthetic polymers, or other materials that would maintain shape in the form of a mold as described in this document for creating a compact-pod. The mold can be scaled up or down for producing a compact-pod of a desired final volume. The mold in this figure represents a mold for creating a single compact-pod, but molds can be assembled in a series for producing more than one compact-pod. To create a compact-pod with a mold, the order of assembly is as follows:
1. Place the Side-Support onto the Base. The Side-Support acts as a funnel.
2. Add the formulation (wet, dry, or some combination of the two) into the Side-Support, which collects mainly in the Base.
3. The Top-Press is then inserted into the Side-Support and pressed down, compacting the formulation into a compact-pod. The mechanical force pressing down on the Top-Press may include, but is not limited to, mechanical pressures, air pressure, or hydraulic pressure.
4. The Top-Press can then be removed, exposing the compact-pod. The compact-pod can then be left to dry as is with the Side-Support still in place or the Side-Support can be removed and the compact-pod can remain in the base and allowed to dry or the compact-pod can be completely removed from the Base (and other parts of the mold) and allowed to dry by itself.
5. After drying the compact-pod, further processing can be carried out on the compact-pod, including but not limited to, further drying/dehydration steps or the addition of coatings.

FIG. 7: A schematic of a mold that can generate a ball or sphere-shaped compact-pod (7A: Top-Press; 7B: Base; 7C: Side-Support)

The mold consists of three parts: Top-Press, Base, and Side-Support. The Side-Support fits on top of the Base and the Top-Press fits into the Side-Support. The mold parts can be fabricated from plastics (including, but not limited to, PLA, ABS, PET), bio-fibers, bio-composites, ceramics, metals (including, but not limited to, aluminum, stainless steel, alloys, magnesium, and copper alloys), silicones, naturally occurring polymers, semisynthetic/synthetic polymers, or other materials that would maintain shape in the form of a mold as described in this document for creating a compact-pod. The mold can be scaled up or down for producing a compact-pod of a desired final volume. The mold in this figure represents a mold for creating a single compact-pod, but molds can be assembled in a series for producing more than one compact-pod. To create a compact-pod with a mold, the order of assembly is as follows:
1. Place the Side-Support onto the Base. The Side-Support acts as a funnel.
2. Add the formulation (wet, dry, or some combination of the two) into the Side-Support, which collects mainly in the Base.
3. The Top-Press is then inserted into the Side-Support and pressed down, compacting the formulation into a compact-pod. The mechanical force pressing down on the Top-Press may include, but is not limited to, mechanical pressures, air pressure, or hydraulic pressure.
4. The Top-Press can then be removed, exposing the compact-pod. The compact-pod can then be left to dry as is with the Side-Support still in place or the Side-Support can be removed and the compact-pod can remain in the base and allowed to dry or the compact-pod can be completely removed from the Base (and other parts of the mold) and allowed to dry by itself.
5. After drying the compact-pod, further processing can be carried out on the compact-pod, including but not limited to, further drying/dehydration steps or the addition of coatings.

### DETAILED DESCRIPTION OF THE PREFERRED EMBODIMENT

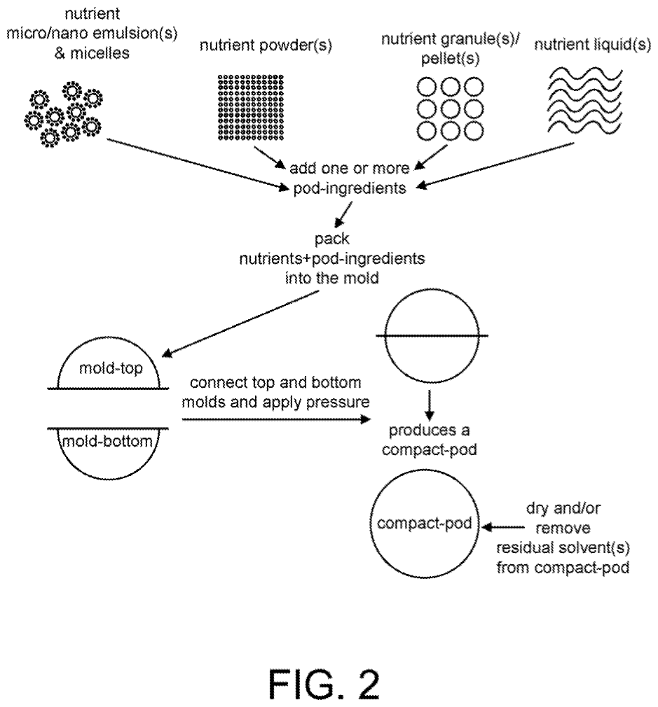

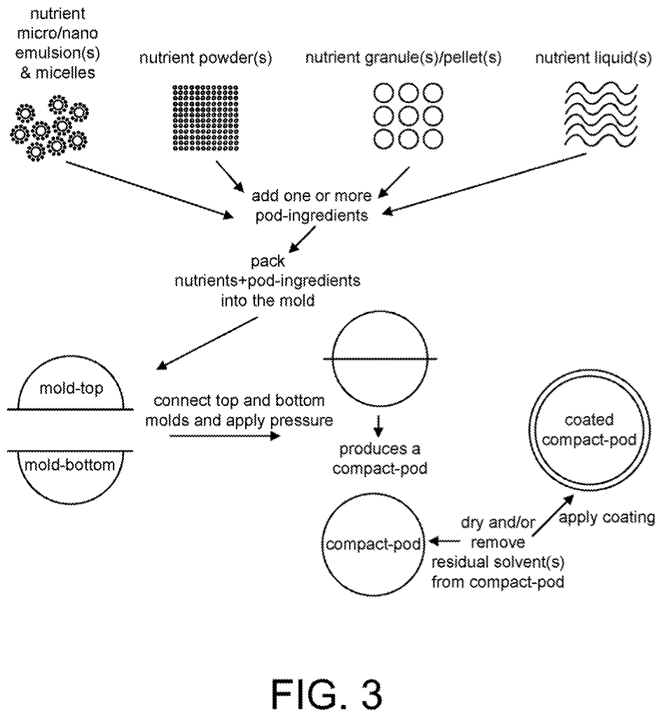

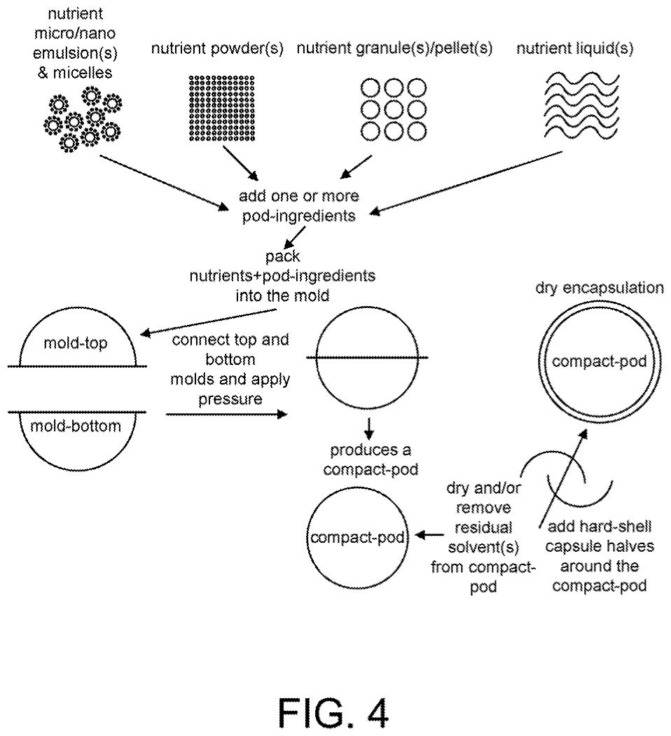

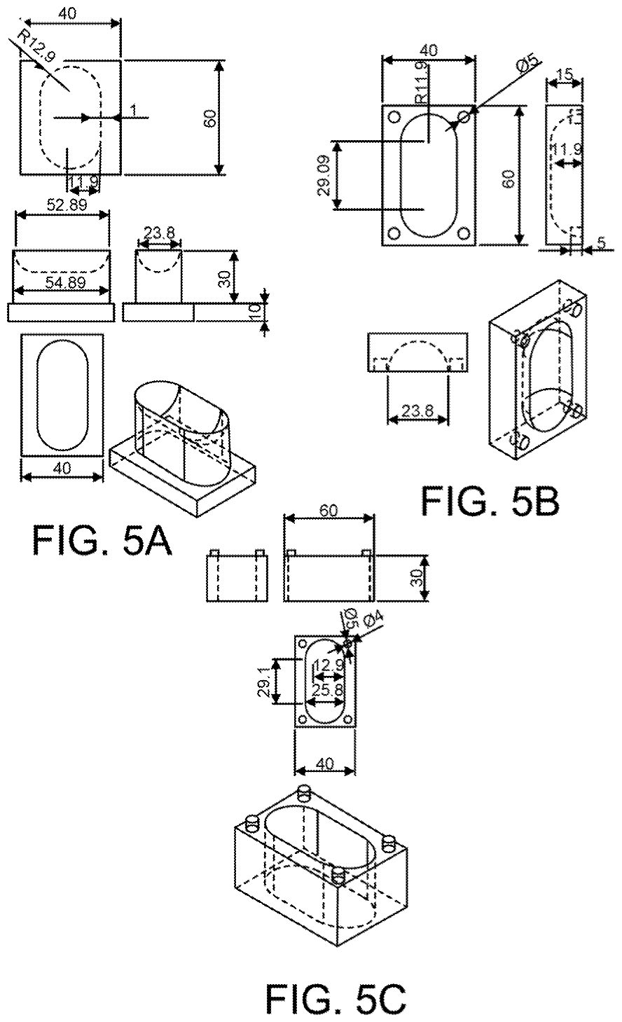

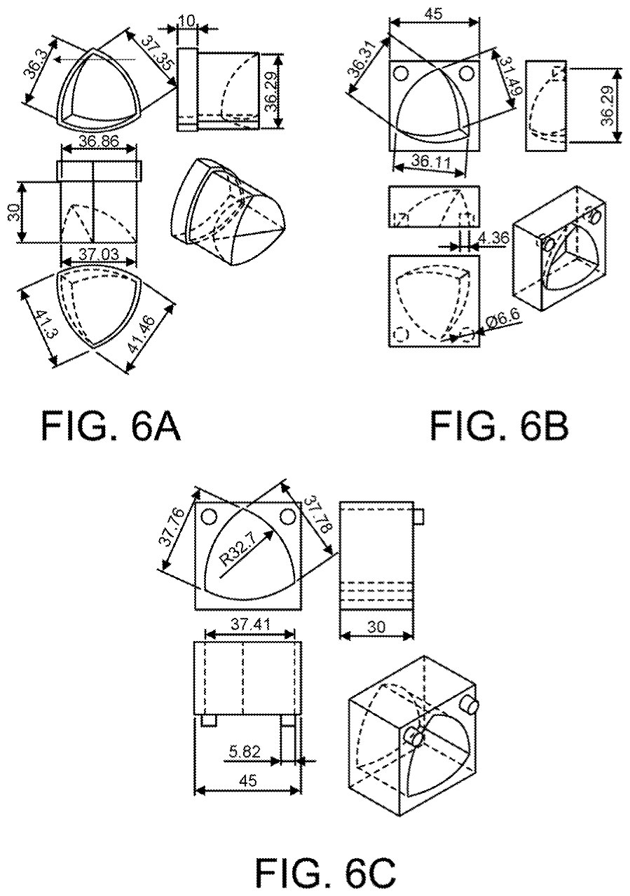

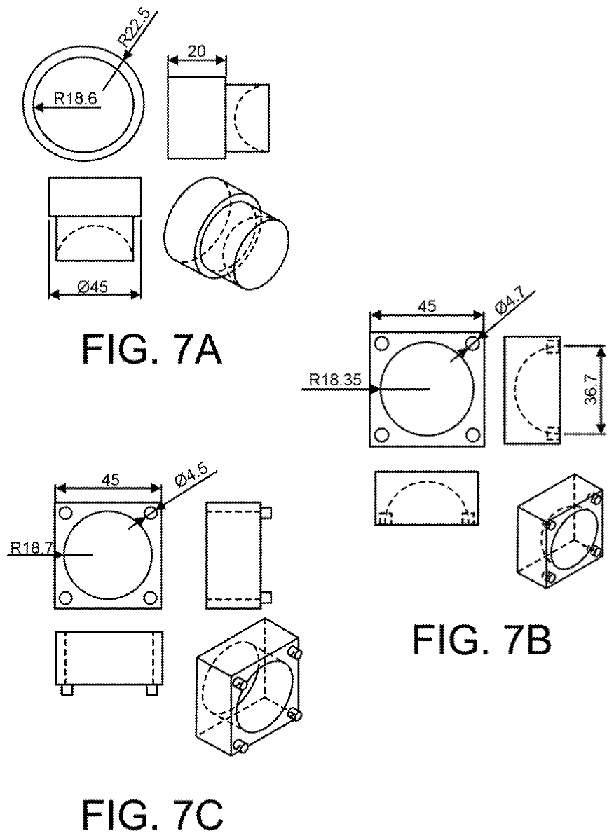

The invention of this compact-pod is comprised of (a) the formulation of pod-ingredients (i.e., the ingredients that help with compaction and dissolution) with nutrient powders/nutrient supplement powders, (b) processes for compacting the formulation (pod-ingredients+nutrients) into a solid compact-pod using a mold and (c) processes for adding a protective coating, film, and/or dry encapsulation; steps (a) and (b) can stand alone as the invention, with step (c) being optional but still part of the invention as it requires at least the completion of steps (a) or (b). The resulting compact-pod uses a specific combination/ratio of nutrients to pod-ingredients and are compacted in a way that allows for the creation of a solid structure strong enough to be held and manipulated in the hand and/or dropped from 1 meter without breaking, but can still readily dissolve (like a bath bomb). This is distinct from simply compacting nutrients/chemicals in a device, like a pill-press, as is typically used in the nutritional and pharmaceutical industries for compacting powders. This application covers the methods/processes of creating compact-pods for all forms of nutrient powders and/or nutrient supplement powders (excluding cannabis derived compounds). The invention allows for the compaction of nutrient(s), of any form(s), into compact-pods that readily dissolve in liquid solution and/or into a suspension. Nutrient forms include, but are not limited to, those in the form of micro/nanoemulsions, micelles, powder(s), granule(s) or nutrient liquid(s). These also include pre-processed nutrients, including but not limited to, granulated powders. The final formulation (pod-ingredients+nutrients) or coating can be customized for a specific nutrient (or any combination of nutrient(s)) to allow for (A) maximal dissolution-rate of the formula into water (or any type of beverage or liquid) and/or (B) manipulation of mechanical properties (e.g., strength, fatigue limit, compression strength, tensile strength, elongation, hardness, and modulus of elasticity) of the compact-pod to modulate dissolution-rate, density, and structural integrity. See FIGS. 2-4 as examples of the potential variety of combinations of nutrients, pod-ingredients, compaction processes, coatings and encapsulations for producing a compact-pod.

Compact-pod formulations fall into two general categories:

Section 1. Hydrophilic (water soluble) nutrient(s) formulation(s). These are formulated into dissolvable compact-pods with the addition of disintegration/compaction formula containing:
disintegrant(s) which allows for rapid expansion and water absorption of the previously compacted compact-pod (0.1-50% w/w of final formulation);
organic acid(s) and carbonate(s), that when combined, act(s) as dissolution agent(s) and produces an effervescing effect (0.1-50% w/w of total formulation);
dietary fiber(s) that acts as a binding agent(s) and increases the mechanical strength of the pod (0.1-50% w/w of total formulation)
a solvent for wet granulation and binding of the formulation (0.1-50% w/v of total formulation); although dry compaction, without solvents, is also sufficient in some formula.

This formulation is then compressed at ≥0.1 MPa into a single compact-pod of any 3-D size or shape. For example, compact-pods can be created at standardized dosages and masses (e.g., 5, 10, and 20 grams), and customizable shapes (e.g., spherical or cylindrical), or the shape a manufacturer's logo. Compact-pod production is then finalized by drying the compact-pod (e.g., using desiccation, vacuum oven, freeze drying, etc.) with or without coating with a soluble natural/semi-synthetic/synthetic fiber or other nutrient/ingredient/material (to strengthen and improve aesthetic of the compact-pod), especially a coating that is appropriate for the intended solvent (e.g., a water-soluble coating for a compact-pod intended to be drunk in water).

Section 2. Hydrophobic (water insoluble) nutrient(s) formulation(s). Additional steps required to formulate compact-pods are as follows:
the nutrient(s) are dissolved in a solvent. For example (but not limited to) organic solvents, such as methanol, ethanol, pentane, or hexane;
amphipathic molecules are combined with the nutrient(s) to form hydrophilic nanoparticles or microparticles of nutrients (i.e., emulsions of micelles, liposomes, or pro-liposomes), encapsulated by the amphipathic molecules. For example (but not limited to), hydrophobin proteins, casein proteins, or late embryogenesis abundant proteins;
if nanoparticles/microparticles cannot be formed with amphipathic molecules when trying dissolve select nutrient(s), a more polar solvent may also be used before mixing into the mainly non-water soluble nutrient formula (producing a heterogeneous mixture).

The nano and/or microparticles may remain in liquid form, or can be subsequently freeze-dried (e.g., by pipetting into liquid nitrogen then placing in a freeze-drying chamber). The resulting nutrient nano/microparticles can be formulated into a compact-pod as previously described above (Section 1).

The above methods can vary or be combined depending on the nutrient(s) being formulated into a compact-pod as to maximize dissolution rate and/or mechanical strength. Examples of compact-pods formulations are listed below in EXAMPLE FORMULATIONS.

### Example of Molds

Mold design can vary widely depending on the compaction method. For example, we made 3-piece systems using a 3D-printer or a CNC machine, both worked equally well, see FIGS. 5-7 as examples. This allowed us to manually add mechanical pressure to the Top-Press to cause compaction. Although FIGS. 5-7 are not the only mold designs, they worked for producing compact pods and are included as part of the process of compaction, part of the invention. This design is not necessary, as many other designs would work, but this 3-piece design is sufficient to produce a compact-pod and is included in the process (step b) portion of this invention.

### Example Formulations

The ratios in the below examples were determined to be optimal for compaction and dissolution-rate (based on experimental data and theory; data described, not included). For a given compact-pod volume, increasing the dissolution agents in the formulation typically resulted in a compact-pod that dissolved faster, however this resulted in less of the desired dose of nutrient(s) available to be present in the compact-pod. For a given compact-pod volume, decreasing the dissolution agents in the formulation typically resulted in a compact-pod that dissolved slower (e.g., >2 minutes), which may unfavorable; although nutrient(s) could be increased in lieu of the space taken up by the dissolution agents for the given volume.

### Example 1: Commercially Available Whey Protein Powder Purchased in Japan (Strawberry, Chocolate or Vanilla Flavors)

Five grams of whey protein powder may be formulated into a dissolvable compact-pod by the addition of the following pod-ingredients, by dry mass:
dissolution agents (1-10% final mass)
a starch derived polysaccharide bulking agent (15-25%)
a cellulose derived polymer as a binding/agglomeration agent (1-5%)
a solvent (1-5%)

This was then mixed and added to a mold and dried at 25-30° C. until complete evaporation of the solvent. The compact-pod was then removed from the mold and spray-coated with the following coating to enhance structure and appearance:
cellulose derived viscoelastic polymer (1%) in solvent;

The coated compact-pod was then dried again at 25-30° C. until complete evaporation of the solvent. The resulting compact-pod self-dissolved into solution in <2 minutes (experientially determined). Also, this resulted in a compact-pod with a compression strength of ˜38-40 newtons before failure, experientially determined for all flavors.

### Example 2: Commercially Available Soy Protein Meal Replacement—Granulated Powder Purchased in Japan (Mixed Berry or Orange Flavor)

Five grams of soy protein meal replacement-granulated powder may be formulated into a dissolvable pod by the addition of the following pod-ingredients:
dissolution agents (5-15% final mass)
a cellulose derived polymer as a binding/agglomeration agent (1-5%)
a solvent (1-5%)

This was mixed and then added to a mold and dried at 25-30° C. until complete evaporation of the solvent. The compact-pod was then removed from the mold and spray-coated with the following coating to enhance structure and appearance:
cellulose derived viscoelastic film-forming polymer (1% in solvent) or 10% rosin in ethanol

The coated compact-pod was then dried again at 25-30° C. until complete evaporation of the solvent. The resulting compact-pod self-dissolved into liquid solution in <2 minutes (experimentally determined). Also, this resulted in a compact-pod with a compression strength of ˜6 newtons until failure for the mixed berry powder and 11 newtons until failure for the orange flavored powder, both experimentally determined.

### Example 3: Vitamin D2 (Ergocalciferol in Casein Micelles)

Insoluble vitamin D2 (ergocalciferol) is encapsulated into (water-soluble) nano-particles as described by in the literature (Dekruif and May, 1991).

The resulting casein micelles can then be nanofiltered and freeze-dried. 50 micrograms of Vitamin D2 is formulated into a dissolvable compact-pod by addition of following dissolution agents:
dissolution agents (1-10% final mass)
a starch derived polysaccharide bulking agent (90%)
a cellulose derived polymer as a binding/agglomeration agent (1-5%)
a solvent (1-5%)

This is then added to a mold and dried at 25-30° C. (until ethanol is completely evaporated). The resulting compact-pod should self-dissolve into liquid solution in <1 minute Micelle development is based the scientific literature. These micelles can then be used as the starting nutrient(s) for developing compact-pods, using the same methods as described for Example 1 or 2.

### Definitions

[a] ‘Nutrient(s)’ are defined here as any natural, synthetic, or semi-synthetic (a) macro-nutrient (protein(s), carbohydrate(s), lipid(s), nucleic acid(s)), (b) micro-nutrient(s) (vitamin(s) and/and mineral(s)), or other compound used by living organisms to maintain homeostasis and/or cellular function. ‘Nutrients’ can be derived from any bacteria and/or fungus and/or plant and/or animal, or be a byproduct of any bacteria and/or fungus and/or plant and/or animal. Note that ‘nutrient(s)’ does not include dehydrated and/or liquid cannabis-derived compound(s) (e.g., macronutrient(s) and/or micronutrient(s) and/or terpinoid(s) and/or flavonoid(s), and/or phytocannabinoid(s)) from any cannabis plant(s); these are not included as ‘nutrient’ in this definition. ‘Nutrient(s)’ include anything regarded as a nutritional supplement(s), whether mentioned above or not.

Nutrients can take the form of:
solids (e.g., powders and/or granules and/or pellets)
liquids (whether in solution and/or suspension)
nanopowders and/or micropowders (nutrient(s) encased in hydrophilic shell)
absorbent materials
processed whole foods (plant, animal, and/or microorganisms-derived)

[b] Dissolution agents are defined here as anything added to the compact-pod formulation with the intention of (but not limited to) any of the following (whether individually or in any combination):
aiding in the breakup (mechanically and/or chemically) of clumps of solid nutrient(s)
increasing the overall solubility of the nutrient(s) in a given liquid solution
producing an effervescing effect in water (or any other liquid)
causing any change in state (i.e., between solid, liquid and gaseous states)

Dissolution agents include (but are not limited to) the following classes of components (whether individual or combined in any manner):
disintegrant(s) or superdisintegrant(s) [d]
organic acid(s) [e]
bicarbarbonate salt(s) [f]

[c] A ‘binding agent(s)’ is defined here as any agent(s) employed to impart cohesiveness to the nutrient(s) (solids, nanoparticles, nanopowders, etc.) or in any mixtures (e.g., nutrients only; nutrients+pod-ingredients) being formulated into the compact-pod during wet or dry granulation (particles sticking together). This ensures the pod remains intact after compression. Natural, semisynthetic, or synthetic polysaccharides are widely used in the pharmaceutical and food industries as excipients and additives due to their lack of toxicity, solubility, availability and low cost, which can function as binding agents. Binging agent(s) may also be referred to as agglomeration agent(s).

Examples of binding agent(s) include (but are not limited to) individual or any combination of compound such as:
gellan gum
xanthan gum
calcium silicate

[d] ‘Disintegrant(s)’ (or ‘superdisintegrant(s)’) are defined here as any agent(s) added to the compact-pod formulations which promote the breakup of the solid, i.e., compact-pod, into smaller fragments in any aqueous environment(s); or nonaqueous liquid environment(s); thereby increasing the available surface area of the compact pod as it breaks down and/or promoting a more rapid release of the nutrient(s). Their actions work through promoting moisture penetration and/or expansion and/or dispersion of the compact-pod formulation and/or coating matrix. Combinations of swelling and/or wicking and/or deformation are the mechanisms of disintegrant action (Remya et al., 2010).

Examples of disintegrant(s) include (but are not limited to) individual or any combination of compound such as:
sodium starch glycolate
croscarmellose sodium

[e] An ‘organic acid’ is defined here as any organic compound with acidic properties. The relative stability of the conjugate base of the acid determines its acidity. Examples of organic acids include (but are not limited to) individual or any combination of acids such as:
Citric acid
Malic acid
Tartaric acid
Ascorbic acid

[f] A ‘bicarbonate salt’ is defined here as any salt of carbonic acid. Carbonate salts contain the polyatomic ion (HCO3)2- and a metal ion. Examples of carbonate salts include (but are not limited to) individual or any combination of compounds such as:
Sodium bicarbonate
Potassium bicarbonate
Magnesium bicarbonate
Calcium bicarbonate

[g] An ‘amphipathic molecule’ is defined here as a chemical compound containing both polar (water-soluble) and nonpolar (non-water-soluble) portions in its structure, otherwise defined as a chemical compound having hydrophobic and hydrophilic regions. These may include for example hydrophobins, which are a large family of amphipathic/amphiphilic fungal protein(s) (˜100 amino acids) that are cysteine-rich. Within the fungus, these are extracellular surface-active proteins which fulfill a broad spectrum of functions in fungal growth and development (Valo et al., 2010). Whilst these naturally occur in fungi, they may be included in the definition and any same or similar protein derived from prokaryotic and/or bacteria and/or plant and/or animal source(s). Another example of an amphipathic molecule is casein, commonly derived from mammalian milk. Late embryogenesis abundant proteins are yet another example of amphipathic molecules.

[h] A ‘compact-pod’ is defined as compacted nutrient(s) of any form with pod-ingredients, whether achieved via compression and/or encapsulation and/or any other means not mentioned here; including or excluding a coating.

[i] A ‘liquid’ or ‘liquid solution’ is defined as any aqueous solution. This includes water or other liquid drinks/beverages, including, but not limited to, juices, teas, milk, soft drinks, fruit punch, energy drinks, non-alcoholic beers, alcoholic beers, and all other non-alcoholic and alcoholic drinks, etc. This covers any solution or suspension which may be consumed by humans and/or plants and/or microorganisms.

[j] A ‘cannabinoid’ is defined as any single molecule which binds to one or multiple “cannabinoid receptor(s)” found in any animal and/or plant and/or microorganism (as agonists, antagonists, partial agonist, inverse agonist, or allosteric regulators).

[k] ‘Cannabinoid receptors’ are defined as any naturally occurring protein or genetically modified protein which is now or may in the future come to be regarded in any peer-reviewed medical and/or scientific publication as an analog and/or homolog and/or ortholog and/or paralog, as the aforementioned “naturally occurring proteins” described above as “cannabinoid receptors”. For example:
Cannabinoid receptor 1 (CB1)
Cannabinoid receptor 2 (CB2)
N-Arachidonyl glycine receptor (NAGly receptor; also termed G protein-coupled receptor 18; GPR18)
G protein-coupled receptor 55 (GPR55)
G protein-coupled receptor 119 (GPR119)
members of the transient receptor potential cation channel subfamily V (TRPV; e.g., TRPV1) members
Any other protein unstated in this patent which is now or may in the future come to be regarded in any peer-reviewed medical and/or scientific publication as a “cannabinoid receptor”

[l] A ‘pod-ingredient’ is any ingredient(s), 50% by dry mass or less of the compact-pod, added to the nutrients that allow for the creation of a compact-pod, including, but not limited to, ingredients that act as dissolution agents, binding agents, acids, bases, disintegrants, superdisintegrants, encapsulation coatings, and/or encapsulation shells.

[m] A ‘cannabis-derived compound(s)’ is any chemical(s) found within the cannabis plant (e.g., Cannabis sativa, Cannabis indica, and Cannabis ruderalis) that has been removed mechanically or chemically or extracted mechanically or chemically, e.g., compounds such as cannabinoids, terpenoids, terpenes, flavonoids, waxes, and lipids from the cannabis plant.

### Exemplar Applications and Configurations

The following are examples of methods and application configurations that may form embodiments of the present invention.

A method of converting existing nutrient(s) (excluding cannabis-derived compounds) into standardized compact-pod unit(s). The unit(s) may or may not contain dispersal mechanism(s) to aid dissolution into any liquid. The method comprising:
one or more nutrient(s) [a]
addition of any dissolution agent(s), whether alone or in combination [b]
compaction into unit(s) of any shape or size
encapsulation into unit(s) of any shape or size; whether fully or partially
encapsulation of nutrients into unit(s) of any shape or size without compaction;
addition of an optional protective coating

In this method, the dissolution agent may be one or more disintegrant(s) (or superdisintegrant(s)) as per definition [d]; may be one or more organic acid(s) as per definition [e]; may be one or more bicarbonate salt(s) as per definition [f]; may be one or more binding and/or agglomeration agent(s) as per definition [c]; may comprise one, all or any combination or all of the dissolution agents; or additional dissolution agents or ingredients.

In alternative embodiments, the addition of a water-soluble or water-insoluble coating may be employed.

In alternative embodiments, one or more nutrients may be encased in hydrophobin(s), and/or any other amphipathic molecule(s) i.e., soy lecithin as per definition [g]; whether processed afterwards (e.g., freeze-dried) or not; also, one or more nutrient(s) may be in any nano and/or microemulsion(s); also, one or more nutrient(s) may be in any nano and/or microemulsion and freeze-dried; also, one of more of the included nutrients may be a coffee, coffee extract, tea and/or tea extract.

Soluble compact pods may be consumed by any living organisms (e.g., drinking). For example:
Compact-pods can be put into liquid solutions. Equally, liquid solutions can be added to compact-pods to dissolve and/or suspend them;
When the compact-pod is dropped/placed into any liquid; it is highly soluble and dissolves, or else forms a suspension, with or without agitation from a mixing tool (e.g., spoon);
When the compact-pod is dropped/placed into liquid solutions; it partially dissolves or suspends, with or without agitation from a mixing tool (e.g., spoon);
When liquid solutions are poured onto the compact-pod; it is highly soluble and dissolves, or else forms a suspension, with or without agitation from a mixing tool (e.g., spoon);
When liquid solutions are poured onto the compact-pod; it partially dissolves or suspends, with or without agitation from a mixing tool (e.g., spoon).

These compact-pods may be soluble in liquids, and/or form suspension(s), and can be used for topical use of organisms (animals, plants, fungi or microorganisms), whether living, deceased, or non-living, or never considered to be alive. For example:
When the compact-pod is dropped/placed into liquid; it is highly soluble and dissolves, and/or forms suspension(s), with or without agitation from a mixing tool (e.g., spoon).
Compact-pods can be put into liquid solutions for soaking and/or cleaning skin (e.g., a ‘bath bomb’) or into other liquid solutions to soak or clean hair or fur.
When the compact-pod is dropped/placed into liquid solutions; it is highly soluble and dissolves, and/or suspends, with or without agitation from a mixing tool (e.g., spoon).
When the compact-pod is dropped/placed into liquid solutions; it partially dissolves, and/or suspends, with or without agitation from a mixing tool (e.g., spoon).
When liquid solutions are poured onto the compact-pod; it is highly soluble and dissolves, and/or suspends, with or without agitation from a mixing tool (e.g., spoon).
When liquid solutions are poured onto the compact-pod; it partially dissolves, and/or suspends, with or without agitation from a mixing tool (e.g., spoon).

These compact-pods may be soluble in liquids, and/or form suspension(s), and can be used for killing organisms or used to enrich non-living objects (e.g., soil).

When the compact-pod is dropped/placed into liquid solutions; it is highly soluble and dissolves, and/or forms suspension(s), with or without agitation from a mixing tool (e.g., spoon). For example:
When the compact-pod is dropped/placed into liquid solutions; it partially dissolves, and/or forms suspension(s), with or without agitation from a mixing tool (e.g., spoon).
When liquid solutions are poured onto the compact-pod; it is highly soluble and dissolves, and/or forms suspension(s), with or without agitation from a mixing tool (e.g., spoon).
When liquid solutions are poured onto the compact-pod; it partially dissolves, and/or forms suspension(s), with or without agitation from a mixing tool (e.g., spoon).

These compact-pod units may be created using above-noted methods using pressure of 0.1 mPa or greater during the compaction process.

These compact-pod units may be created using above-noted methods in any type of mold, including, but not limited to, molds fabricated from plastics (including, but not limited to PLA, ABS, and PET), bio-fibers, bio-composites, ceramics, metals (including, but not limited to, aluminum, stainless steel, alloys, magnesium, and copper alloys), silicones, naturally occurring polymers, or semisynthetic/synthetic polymers. The 3-piece mold design described in FIGS. 5-7 is part of this invention, namely as a process step. The 3-piece mold design is sufficient, but is not the only type of mold system that can produce compact-pods.

These compact-pod units may be created using the above-noted methods, using molds made from cutting into a larger starting material (e.g., a rectangular aluminum slab) to generate the desired shape using tools/instruments such as, but not limited to, a laser cutter, etcher, a CNC machine or a water jet cutter.

These compact-pod units may be created using the above-noted methods, using molds made from building the desired mold shape using a 3D printer or injection molding.

These compact-pod units may be created using the above-noted methods, namely using any type of mold of any shape (including, but not limited to, molds constructed of metals, plastics, or silicon) using pressure to cause compaction including, but not limited to, in the form of mechanical pressure, air pressure, fluid pressure, vacuum pressure and/or electrostatic pressure.

While the preferred embodiment of the invention has been illustrated and described, as noted above, many changes can be made without departing from the spirit and scope of the invention. Accordingly, the scope of the invention is not limited by the disclosure of the preferred embodiment. Instead, the invention should be determined entirely by reference to the claims that follow.

1. A method of converting a nutrient or a nutrient supplement into a compact-pod unit, comprising:
combining at least one of a nutrient or a nutrient supplement with a dissolution agent to create a formula;
adding at least one binding agent to the formula;
compacting the resulting formula into a compact-pod unit of any 3-dimensional shape or size; and
at least partially coating the compact-pod unit.

2. The method of claim 1, further comprising using a dispersal mechanism to aid dissolution of the compact-pod unit into any liquid.

3. The method of claim 1, further comprising fully covering the compact-pod unit with a protective coating.

4. The method of claim 1, wherein the dissolution agent is at least one of a disintegrant or superdisintegrant.

5. The method of claim 1, wherein the dissolution agent is an organic acid.

6. The method of claim 1, wherein the dissolution agent is a bicarbonate salt.

7. The method of claim 1, wherein the dissolution agent comprises at least two from the group of a disintegrant or superdisintegrant, an organic acid, a bicarbonate salt and a binding agent or an agglomeration agent.

8. The method of claim 1, further comprising applying at least partially to the compact-pod unit a water-soluble or a water-insoluble coating.

9. The method of claim 1, wherein the at least one nutrient is a hydrophobin molecule.

10. The method of claim 1, wherein the at least one nutrient is an amphipathic molecule.

11. The method of claim 1, wherein the at least one nutrient is a wet or dry emulsion.

12. The method of claim 1, wherein the at least one nutrient is freeze-dried.

13. The method of claim 1, wherein the at least one nutrient is coffee or a coffee extract.

14. The method of claim 1, wherein the at least one nutrient is tea or a tea extract.

15. The method of claim 1, wherein compaction occurs with a mold.

16. The method of claim 1, further comprising at least partially encapsulating the compact-pod unit using a solid material.

17. The method of claim 1, wherein the binding agent is polysaccharide.
